(19) United States
(12) Patent Application Publication
(10) Pub. No.: US 2009/0122066 A1
(43) Pub. Date: May 14, 2009

(54) DRAWING-EDITING SYSTEM AND APPARATUS AND GROUPING PROCESSING METHOD

(75) Inventor: Tadahiko Iijima, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/266,887

(22) Filed: Nov. 7, 2008

(30) Foreign Application Priority Data
Nov. 9, 2007 (JP) 2007-292307

(51) Int. Cl. G06T 11/20

(52) U.S. Cl. 345/441

(57) ABSTRACT

The drawing-editing system includes a drawing processing unit which draws a drawing object based on an input from a coordinate input apparatus, a calculation unit which calculates a first speed indicating a drawing speed upon drawing of a first drawing object drawn by the drawing processing unit, and a second speed indicating a moving speed from the drawing end position of the first object to the drawing start position of the next second drawing object to be drawn, a determination unit which determines, based on information calculated by the calculation unit, whether to group the first drawing object and the second drawing object, and a grouping processing unit which executes grouping of the first drawing object and the second drawing object based on the determination result of the determination unit.

### BACKGROUND OF THE INVENTION

1. Field of the Invention

The present invention relates to a drawing-editing system and apparatus and grouping processing method, more specifically, executing groupings of drawing objects.

2. Description of the Related Art

A drawing-editing system normally incorporates drawing software which lays out drawing objects, sets respective objects, and executes editing for each object. In general, the drawing software comprises a grouping function of combining the properties of a plurality of objects.

Drawing software which assumes the use of a hand-writing input device has a function of grouping one character as one object, and a function of grouping a continuous character string.

Conventionally, as for groupings of this type, a method that combines spatial grouping and temporal grouping has been proposed. For example, in one such method, when there are a plurality of drawing objects, if an object which is drawn temporally first and that which is drawn temporally last are selected, drawing objects created between these two objects are grouped. Another method groups drawing objects which are temporally continuous and have a close distance (Japanese Patent Laid-Open No. 6-44021).

However, with the technique described in Japanese Patent Laid-Open No. 6-44021 above, when drawing objects have a large distance, even when an operator tries to continuously draw them, these objects may be determined as different groups. This may occur, for example, when the operator has spent too much time for movement to a drawing start position of an object to be continuously drawn.

On the other hand, when the operator is not trying to continuously draw objects, if the positions of the drawing objects are close to each other or the time before drawing of the next drawing object is short, these objects may be grouped unintentionally.

In the case of an operator who draws fast, many drawing objects may be grouped as one group. Or in the case of an operator who draws slowly, many drawing objects may be grouped as different groups. Also, slow drawing and rapid drawing by a single operator may change grouping configurations.

### SUMMARY OF THE INVENTION

An embodiment of the present invention allows a drawing-editing system, grouping processing method, program, and drawing-editing apparatus, which allow grouping of drawing objects closer to an operator's intention to be provided.

According to a first aspect of the present invention, there is provided a drawing-editing system comprising: a drawing processing unit configured to draw a drawing object based on an input from a coordinate input apparatus; a calculation unit configured to calculate a first speed indicating a drawing speed upon drawing of a first drawing object drawn by the drawing processing unit, and a second speed indicating a moving speed from a drawing end position of the first object to a drawing start position of a next, second drawing object to be drawn; a determination unit configured to determine, based on information calculated by the calculation unit, whether to group the first drawing object and the second drawing object; and a grouping processing unit configured to execute grouping of the first drawing object and the second drawing object based on a determination result of the determination unit.

According to a second aspect of the present invention, there is provided a grouping processing method for a drawing-editing system, comprising the steps of: drawing a drawing object based on an input from a coordinate input apparatus; calculating a first speed indicating a drawing speed upon drawing of a first drawing object drawn in the drawing step, and a second speed indicating a moving speed from a drawing end position of the first object to a drawing start position of a next second drawing object to be drawn; determining, based on information calculated in the calculation step, whether to group the first drawing object and the second drawing object; and executing grouping of the first drawing object and the second drawing object based on a determination result of the determining step.

According to a third aspect of the present invention, there is provided a drawing-editing program stored on a computer-readable medium for making a computer function as: a drawing processing unit configured to draw a drawing object based on an input from a coordinate input apparatus; a calculation unit configured to calculate a first speed indicating a drawing speed upon drawing of a first drawing object drawn by the drawing processing unit, and a second speed indicating a moving speed from a drawing end position of the first object to a drawing start position of a next, second drawing object to be drawn; a determination unit configured to determine, based on information calculated by the calculation unit, whether to group the first drawing object and the second drawing object; and a grouping processing unit configured to execute grouping of the first drawing object and the second drawing object based on a determination result of the determination unit.

According to a fourth aspect of the present invention, there is provided a drawing-editing apparatus comprising: a drawing processing unit configured to draw a drawing object based on an input from a coordinate input apparatus; a calculation unit configured to calculate a first speed indicating a drawing speed upon drawing of a first drawing object drawn by the drawing processing unit, and a second speed indicating a moving speed from a drawing end position of the first object to a drawing start position of a next, second drawing object to be drawn; a determination unit configured to determine, based on information calculated by the calculation unit, whether to group the first drawing object and the second drawing object; and a grouping processing unit configured to execute grouping of the first drawing object and the second drawing object based on a determination result of the determination unit.

Further features of the present invention will become apparent from the following description of exemplary embodiments with reference to the attached drawings.

### BRIEF DESCRIPTION OF THE DRAWINGS

FIG. 1 is a view showing an example of a drawing-editing system according to one embodiment of the present invention;

FIG. 2 is a block diagram showing an example of the functional arrangement of the drawing-editing system shown in FIG. 1;

FIG. 3 is a block diagram showing an example of the functional arrangement implemented by a CPU 201 shown in FIG. 2;

FIG. 4 is a first view showing an example of an overview of processing in the drawing-editing system;

FIG. 5 is a second view showing an example of an overview of processing in the drawing-editing system;

FIG. 6 is a third view showing an example of an overview of processing in the drawing-editing system;

FIGS. 7A to 7B are fourth views showing an example of an overview of processing in the drawing-editing system;

FIG. 8 is a fifth view showing an example of an overview of processing in the drawing-editing system;

FIG. 9 is a flowchart showing an example of the sequence of processing in the drawing-editing system; and

FIG. 10 is a view showing an example of a drawing-editing system.

### DESCRIPTION OF THE EMBODIMENTS

An exemplary embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

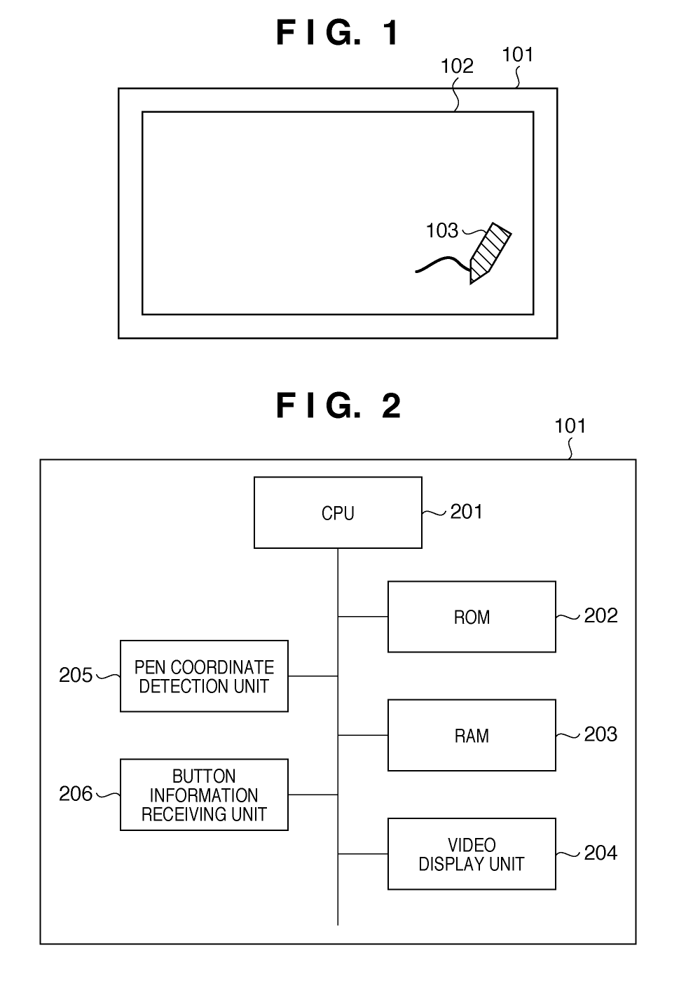

FIG. 1 is a view showing an example of a drawing-editing system according to one embodiment of the present invention.

A display 101 has a display apparatus with a coordinate input function, and displays a video on a screen 102. The display 101 incorporates a drawing-editing program. The display 101 executes processing based on input information (e.g., coordinates, button information) input using a pen 103 according to this program.

The pen 103 comprises of a pressure sensor in a pen tip, and has a structure in which a switch is turned on while the pen is pressed against the screen 102. The pen 103 transmits button information of the pen tip switch to the display 101 using infrared rays or the like. A position where the pen 103 is pressed against the screen 102 is read as coordinates by a digitizer function of the display 101. The coordinates are read by monitoring a state in which light emitted from an upper portion of the display 101 is intercepted. Note that reading of the coordinates may be implemented using a pen which comprises an electromagnetic, electrostatic, or other means such as a coordinate input plate or the like.

FIG. 2 is a block diagram showing an example of the functional arrangement of the drawing-editing system shown in FIG. 1. Note that the same reference numerals in FIG. 2 denote the same components as in FIG. 1.

A pen coordinate detection unit 205 detects the coordinate position of the pen 103 which points to a certain position on the screen 102. A button information receiving unit 206 receives button information of the pen 103 which is transmitted from the pen 103 using infrared rays or the like. A CPU (Central Processing Unit) 201 controls the operation of the overall display 101 in accordance with a control program stored in a ROM 202. In addition, the CPU 201 executes input/output control, data processing, and the like of various data.

The ROM (Read Only Memory) 202 stores a program required to execute control according to this embodiment, and various data. A RAM (Random Access Memory) 203 is used as a work area when the CPU 201 executes the control program, and temporarily stores various calculation results, coordinate data, and the like. A video display unit 204 has a display panel, and displays video data on the screen 102 based on an instruction of the CPU 201.

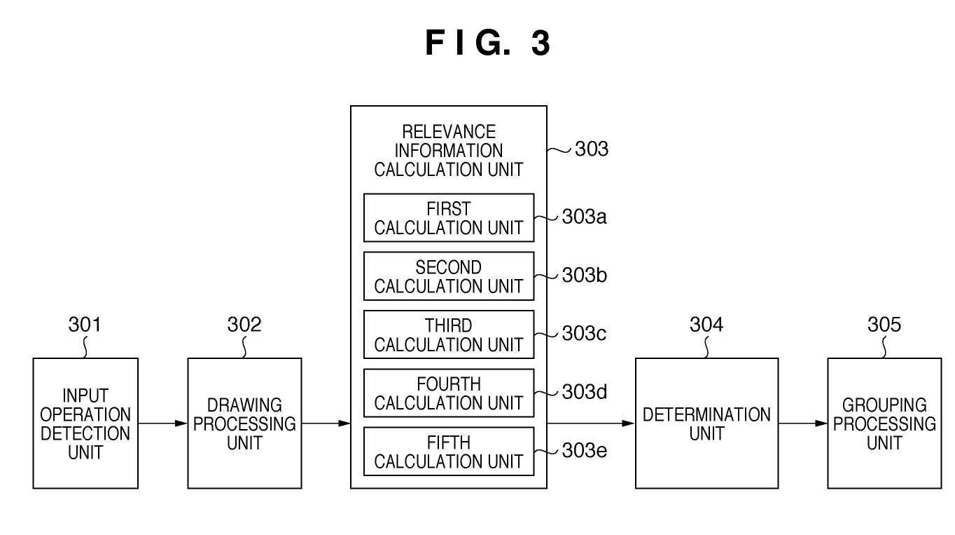

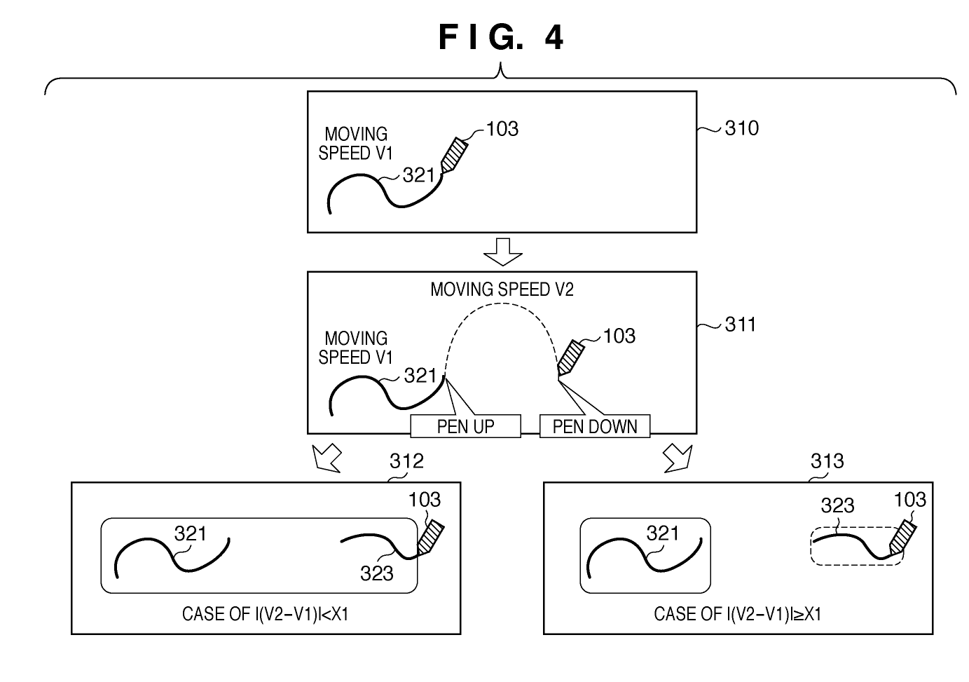

FIG. 3 is a block diagram showing an example of the functional arrangement implemented by the CPU 201 shown in FIG. 2. Note that various processing functions to be implemented by the CPU 201 are mainly implemented when the CPU 201 executes a control program (for example, a drawing-editing program) stored in the ROM 202.

An input operation detection unit 301 detects a coordinate input operation using the pen 103. The input operation detection unit 301 of this embodiment, for example, detects, as a pen-down operation, a state in which the pen 103 is in contact with the display screen, as a pen-up operation, a state in which the pen 103 is not in contact with the display screen, and, as a drag operation, a state in which the pen 103 is moved while it is kept in contact with the display screen. Note that the input operation is detected based on the pen coordinate detection result by the pen coordinate detection unit 205 and the reception result of button information by the button information receiving unit 206.

A drawing processing unit 302 executes drawing based on coordinates input according to the coordinate input operation. The aforementioned video display unit 204 displays, on the screen 102, a drawing object based on the coordinate input operation according to a drawing instruction from this drawing processing unit 302.

A relevance information calculation unit 303 calculates relevance information generated between drawing objects upon determining whether or not to group the drawing objects. Note that the relevance information calculation unit 303 calculates relevance information, for example, using mathematical formulas. The relevance information indicates temporal or spatial information generated between drawing objects. The relevance information calculation unit 303 comprises first, second, third, fourth, and fifth calculation units 303a, 303b, 303c, 303d, and 303e, so as to calculate this relevance information. Note that relevance information to be calculated by each of the respective calculation units 303a to 303e will be described later.

A determination unit 304 determines whether or not to group drawing objects. This determination is made based on some or all pieces of relevance information calculated by the aforementioned calculation units.

A grouping processing unit 305 groups drawing objects. The grouping processing unit 305 executes grouping based on the determination result of the aforementioned determination unit 304.

An example of an overview of processing in the aforementioned drawing-editing system will be described below with reference to FIGS. 4 to 9. FIGS. 4 to 9 show an overview of grouping processing when the user continuously draws drawing objects. Note that a case will be exemplified below wherein each drawing object is a curve.

A case will be described first with reference to FIG. 4 wherein grouping determination is made based on a moving speed of input coordinates.

First, the user draws a first drawing object (to be referred to as a curve 321 in the description of FIG. 4) by moving the pen 103 while dragging it on the screen 102 (310). Note that the first calculation unit 303a shown in FIG. 3 calculates the moving speed of the pen 103 upon drawing this curve 321 (i.e., the drawing speed), that is, a first speed of input coordinates (to be referred to as a moving speed V1 hereinafter).

After the curve 321 is drawn, the user makes a pen-up operation of the pen 103 from the screen 102, moves the pen 103 to the drawing start position of a second drawing object (to be referred to as a curve 323 in the description of FIG. 4), and makes a pen-down operation of the pen 103 onto the screen 102 (311).

After the pen-down operation, the user drags the pen 103 to draw the second drawing object. Note that the second calculation unit 303b shown in FIG. 3 calculates a second speed of the input coordinates from the drawing end position of the curve 321 until the drawing start position of the curve 323 (to be referred to as a moving speed V2 hereinafter). The moving speed V2 is calculated by dividing the distance from the pen-up position to the pen-down position by the time duration from the pen-up timing to the pen-down timing. Note that “pen-up” indicates a timing or state when the user disengages the pen 103 from the screen 102 after completion of drawing of the curve 321. Likewise, “pen-down” indicates a timing or state when the user brings the pen 103 into contact with the screen 102 to draw the curve 323.

After completion of drawing of the two curves, the drawing-editing system determines whether or not to group the curves 321 and 323 as one group, and executes grouping of the two curves based on that determination result. Whether or not to group objects is determined by calculating the absolute value of a formula (V2-V1), and checking if the calculated value falls within a predetermined range (within a predetermined value X1).

If the absolute value of (V2-V1) is less than the predetermined value X1, since there is no large difference between the moving speed of the pen after the pen-up operation and that of the pen upon drawing of the curve 321 (i.e., drawing speed), the system recognizes that the two curves are continuous, and groups the curves 321 and 323 as the same group (312). On the other hand, if the absolute value of (V2-V1) is greater than or equal to the predetermined value X1, since the moving speed of the pen after the pen-up operation is largely different from that of the pen upon drawing of the curve 321, the system recognizes that the two curves are not continuous, and groups the curves 321 and 323 as different groups (313).

The overview of the processing upon making grouping determination based on the moving speed of the input coordinates has been described.

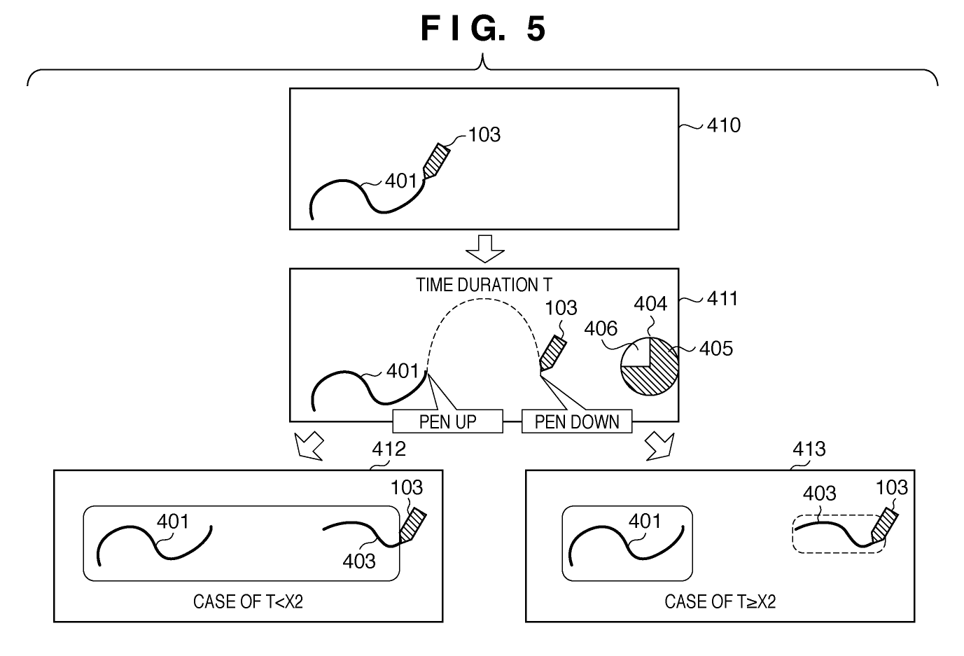

A case will be described below with reference to FIG. 5 wherein grouping determination is made based on a time duration from the pen-up timing until the pen-down timing.

Assume that the user has made the same operations as in FIG. 4. As a result of the operations, a first drawing object (to be referred to as a curve 401 in the description of FIG. 5) and a second drawing object (to be referred to as a curve 403 in the description of FIG. 5) are drawn. After completion of drawing, the drawing-editing system determines whether or not to group the curves 401 and 403 as the same group, and executes grouping of the two curves based on the determination result. Whether or not to group objects is determined by checking if a time duration T from the pen-up timing to the pen-down timing falls within a predetermined range (within a predetermined value X2). Note that the third calculation unit 303c shown in FIG. 3 calculates the time duration T from the drawing end timing of the curve 401 until the drawing start timing of the curve 403 (410, 411). Note that “pen-up” indicates a timing or state when the user disengages the pen 103 from the screen 102 after completion of drawing of the curve 401. Likewise, “pen-down” indicates a timing or state when the user brings the pen 103 into contact with the screen 102 to draw the curve 403.

As a result, if the time duration T is less than the predetermined value X2, since the elapsed time duration between the drawing end timing of the curve 401 and the drawing start timing of the curve 403 is short, the system recognizes that the two curves are continuous, and groups the curves 401 and 403 in the same group (412). On the other hand, if the time duration T is greater than or equal to the predetermined value X2, since the elapsed time duration between the drawing end timing of the curve 401 and the drawing start timing of the curve 403 is long, the system recognizes that the two curves are not continuous, and groups the curves 401 and 403 in different groups (413).

At this time, an indicator 404 may be displayed so as to allow the operator to recognize whether or not the next curve 403 to be drawn is grouped into the same group as the previously drawn curve 401. The indicator 404 is displayed in a reset state simultaneously with the pen-up operation. The region of a sector form 405 increases and the region of a sector form 406 decreases as time elapses. The sector form 405 represents the time duration elapsed after the pen-up operation, and the sector form 406 represents the remaining time duration within which the next curve to be drawn is grouped into the same group as the curve 401. When the user draws a curve after the region of the sector form 406 becomes zero, that curve is grouped as a group different from that of the curve 401.

Note that FIG. 5 has exemplified the indicator defined by a circle and sector forms. However, the present invention is not limited to this. Other methods may be used as long as they allow the operator to recognize a time duration within which an object to be drawn is grouped to the same group as the previously drawn drawing object. For example, the remaining time may be simply displayed using text information.

An overview of the processing when grouping determination is made based on the time duration from the pen-up timing until the pen-down timing has been described. Note that whether or not to group objects may be determined by combining the processing described using FIG. 5 and that described using FIG. 4. That is, when the speed difference between the moving speeds V1 and V2 falls within the predetermined range, and the time duration T also falls within the predetermined range, it may be determined that two objects are grouped as the same group.

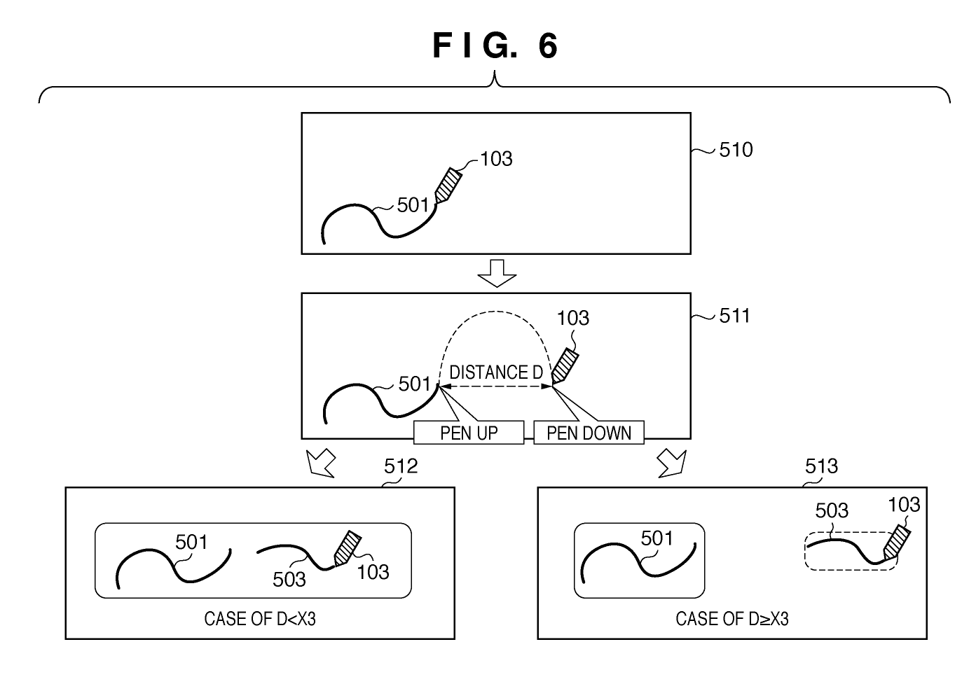

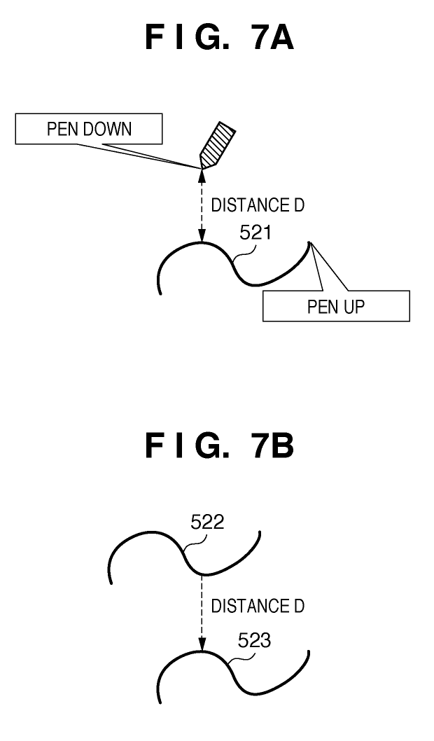

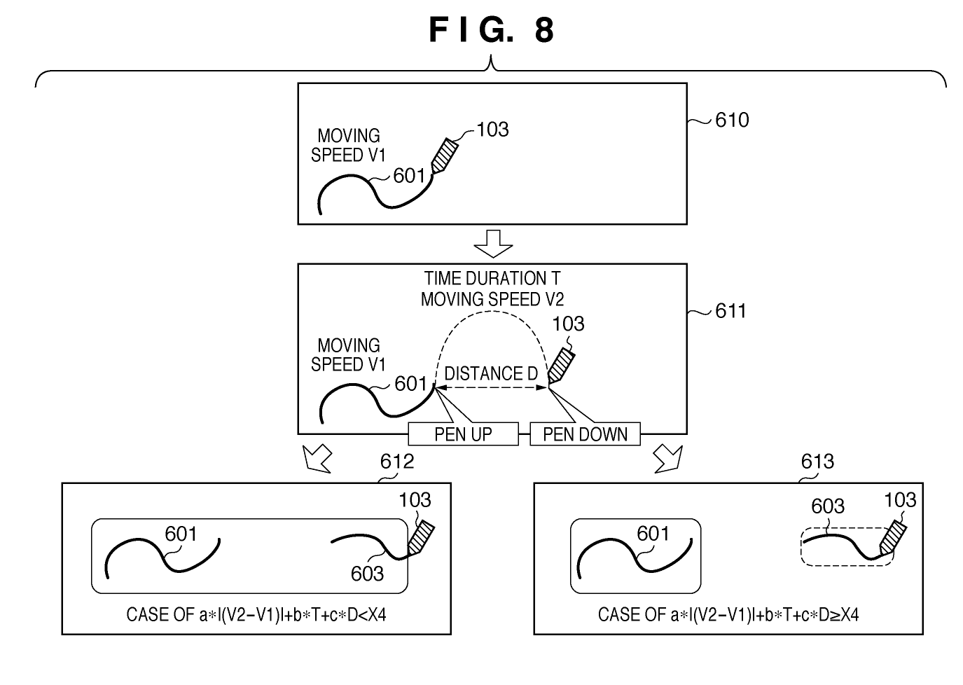

A case will be described below with reference to FIG. 6 and FIGS. 7A and 7B wherein grouping determination is made based on the distance from the pen-up position to the pen-down position.

In FIG. 6, assume that the user has made the same operations as in FIG. 4. As a result of the operations, a first drawing object (to be referred to as a curve 501 in the description of FIG. 6) and a second drawing object (to be referred to as a curve 503 in the description of FIG. 6) are drawn. After completion of drawing, the drawing-editing system determines whether or not to group the curves 501 and 503 as the same group, and executes grouping of the two curves based on the determination result. Whether or not to group objects is determined by checking if a distance D from the pen-up position to the pen-down position falls within a predetermined range (within a predetermined value X3) (510, 511). Note that the fourth calculation unit 303d shown in FIG. 3 calculates the distance D between the curves 501 and 503. Note that “pen-up” indicates a timing or state when the user disengages the pen 103 from the screen 102 after completion of drawing of the curve 501. Likewise, “pen-down” indicates a timing or state when the user brings the pen 103 into contact with the screen 102 to draw the curve 503.

As a result, if the distance D is less than the predetermined value X3, since the curve 503 is drawn near the curve 501, the system recognizes that the two curves are continuous, and groups the curves 501 and 503 as the same group (512). On the other hand, if the distance D is greater than or equal to the predetermined value X3, since the curve 503 is drawn at a position separated away from the curve 501, the system recognizes that the two curves are not continuous, and groups the curves 501 and 503 as different groups (513).

Note that FIG. 6 explains the case in which grouping determination is made based on the distance from the pen-up position to the pen-down position. However, the present invention is not limited to this, and determination may be made based on the distance between specific positions on drawing objects. For example, in place of the distance between the pen-up and pen-down positions, determination may be made to have a shortest distance from the pen-down position to a previously drawn drawing object (a curve 521 in this case) as the distance D, as shown in FIG. 7A. Also, as shown in FIG. 7B, determination may be made to have a shortest distance between two drawing objects (curves 522 and 523 in this case) as the distance D.

An overview of the processing when grouping determination is made based on the distance from the pen-up position to the pen-down position has been described. Note that whether or not to group objects may be determined by combining the processing described using FIG. 6 and that described using FIG. 4. That is, when the speed difference between the moving speeds V1 and V2 falls within the predetermined range, and the distance D also falls within the predetermined range, it may be determined that two objects are grouped as the same group. Furthermore, by combining the processing described using FIG. 5 to this arrangement, when the speed difference between the moving speeds V1 and V2 falls within the predetermined range, the distance D falls within the predetermined range, and the time duration D falls within the predetermined range, it may be determined that two objects are grouped as the same group.

A case will be described below with reference to FIG. 8 wherein grouping determination is made based on a result obtained by processing the above pieces of relevance information using an evaluation function. FIG. 8 will exemplify a case in which the moving speeds V1 and V2 of the pen 103, the time duration T from the pen-up timing until the pen-down timing, and the distance D from the pen-up position to the pen-down position, which are calculated in the aforementioned sequences, are processed using an evaluation function.

Assume that the user has made the same operations as in FIG. 4. As a result of the operations, a first drawing object (to be referred to as a curve 601 in the description of FIG. 8) and a second drawing object (to be referred to as a curve 603 in the description of FIG. 8) are drawn. Likewise, assume that the moving speed of the pen upon drawing of the curve 601 (i.e., the drawing speed) is calculated as V1, the moving speed of the pen from the drawing end position of the curve 601 to the drawing start position of the curve 603 is calculated as V2, the distance between the two curves is calculated as D, and the time duration is calculated as T (610, 611).

After completion of drawing, the drawing-editing system determines whether or not to group the curves 601 and 603 as the same group, and executes grouping of the two curves based on the determination result. Whether or not to group objects is determined by checking if a value obtained by respectively multiplying the absolute value of the formula (V2-V1), the distance D, and the time duration T by weights, and adding these products falls within a predetermined range (within a predetermined value X4). Note that the fifth calculation unit 303e shown in FIG. 3 calculates the value obtained by respectively multiplying the absolute value of the formula (V2-V1), the distance D, and the time duration T by weights, and adding these products, that is, an evaluation value obtained by processing the absolute value of the formula (V2-V1), the distance D, and the time duration T using an evaluation function.

As a result, if the evaluation value is less than the predetermined value X4, since the spatial and temporal relevances between the curves 601 and 603 are strong, the system recognizes that the two curves are continuous, and groups the curves 601 and 603 as the same group (612). On the other hand, if the evaluation value is greater than or equal to the predetermined value X4, since the spatial and temporal relevances between the curves 601 and 603 are weak, the system recognizes that the two curves are not continuous, and groups the curves 601 and 603 as different groups (613).

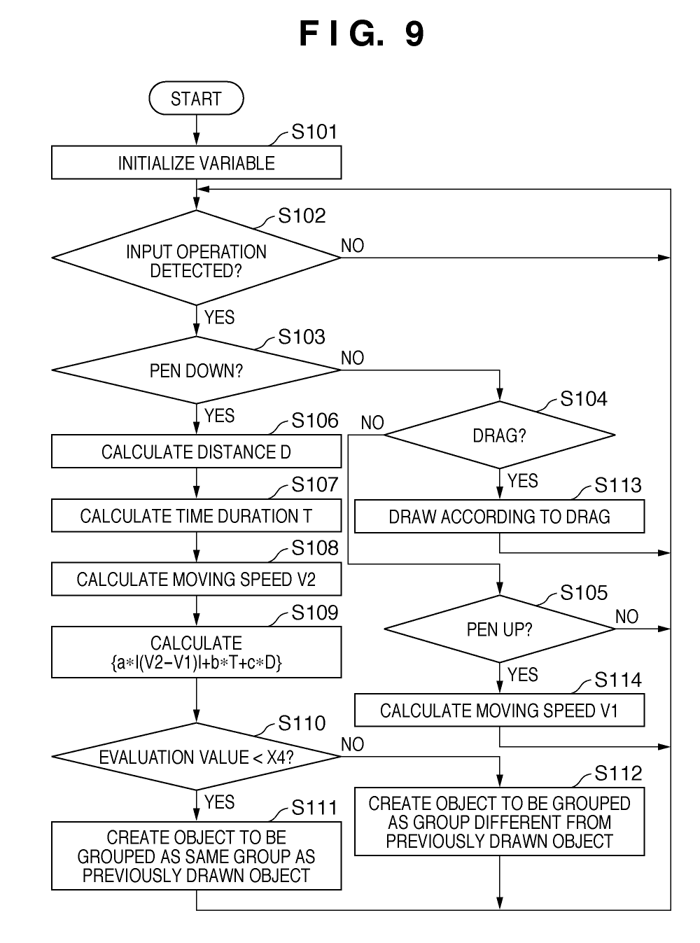

The sequence of processing in the aforementioned drawing-editing system will be described below with reference to FIG. 9. FIG. 9 is a flowchart upon grouping drawing objects by the method described using FIG. 8 as an example of the processing in the drawing-editing system.

Upon starting this processing, the drawing-editing system initializes variables (step S101). The input operation detection unit 301 of the drawing-editing system detects an input operation using the pen 103 (step S102).

If a pen-down operation is detected (YES in step S103), the third calculation unit 303c calculates a distance D from the pen-up position of a drawing object which is drawn linearly to this pen-down position (step S106). The fourth calculation unit 303d calculates a time duration T (step S107), and the second calculation unit 303b divides the calculated distance D by the calculated time duration T to calculate a speed V2 at which the pen has been moved without contacting the screen (step S108). The fifth calculation unit 303e calculates, as an evaluation value, a value obtained by respectively multiplying the absolute value of (V2-V1), the time duration T, and the distance D by weights, and adding these products (step S109). The determination unit 304 determines if the evaluation value is less than the predetermined value X4 (step S110).

As a result, if the evaluation value is less than the predetermined value X4 (YES in step S110), the grouping processing unit 305 creates an object as the same group as the previously drawn drawing object (step S111), and the process returns to the process of step S102. If the evaluation value calculated in step S109 is greater than or equal to the predetermined value X4 (NO in step S110), the grouping processing unit 305 creates an object as a group different from the previously drawn drawing object (step S112), and the process returns to the process of step S102.

If the input operation detected in step S102 is a drag operation (after NO in step S103, YES in step S104), the drawing processing unit 302 executes drawing based on the drag operation (step S113), and the process returns to the process of step S102.

If the input operation detected in step S102 is a pen-up operation (after NO in steps S103 and S104, YES in step S105), the first calculation unit 303a calculates a moving speed V1 (step S114). After that, the process returns to the process of step S102. If the input operation detected in step S101 corresponds to none of the aforementioned operations (NO in steps S103 to S105), the process returns to the process of step S102.

Note that FIG. 9 adopts the configuration in which the evaluation value is calculated using the evaluation function that respectively multiplies the absolute value of (V2-V1), the time duration T, and the distance D by weights, and adds these products in step S109 to make a determination. However, the present invention is not limited to this method. For example, a determination may be made based on a result obtained by processing the moving speeds V1 and V2 and the time duration T using an evaluation function. Alternatively, a determination may be made based on a result obtained by processing the moving speeds V1 and V2 and the distance D using an evaluation function.

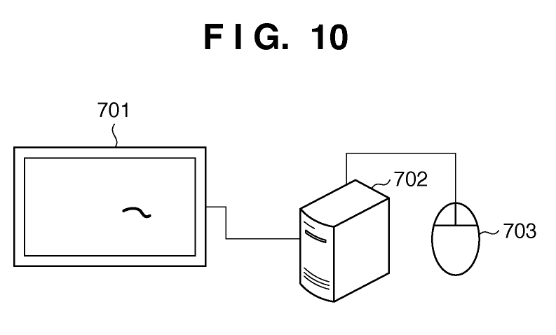

Note that the above embodiment has exemplified the drawing-editing system in which the display includes the coordinate input function, button information receiving unit, and drawing-edit program. However, the present invention is not limited to such a specific arrangement. For example, a system may be configured using a personal computer (to be referred to as a PC hereinafter), as shown in FIG. 10. In a system using a PC 702, a drawing-edit program (for example, the processing described using the flowchart of FIG. 9) runs on the PC 702. In this case, the PC 702 makes a display on a display 701 based on coordinates, button information, and the like sent from a coordinate input apparatus such as a mouse 703 or the like.

As described above, according to the above embodiment, grouping of drawing objects closer to an operator's intention can be made. For example, when the operator moves the pen to the drawing start position of the next drawing object at the same speed as the moving speed of input coordinates upon drawing of the previously drawn drawing object, even when the next drawing start position is separated away from the drawing end position, the next drawing object can be grouped as the same group as the previously drawn drawing object. By contrast, when the operator moves the pen to the drawing start position of the next drawing object at a speed lower than the moving speed of input coordinates upon drawing of the previously drawn drawing object, even when the drawing objects are located at close positions, the two objects can be grouped as different groups.

Also, when a slight time duration is set until drawing of a continuous drawing object, even when the drawing objects are located at close positions, the two objects can be grouped as different groups. By contrast, when a time duration until drawing of a continuous drawing object is shortened, even when the two drawing objects are located at separate positions, the two objects can be grouped as the same group.

The embodiments have been explained in detail. The present invention can adopt embodiments in the forms of, for example, a system, apparatus, method, storage medium, and the like. The present invention may be applied to either a system constituted by a plurality of devices, or an apparatus consisting of a single device.

The present invention may also be practiced by supplying a medium such as a storage medium having a software program code stored therein to an apparatus, loading the software program code from the medium onto a computer (or a CPU or an MPU) of a system or an apparatus, and executing the software program on the computer.

In this case, the program code read from the storage medium implements the novel functions disclosed in the embodiments described above, and the storage medium on which the program code is stored falls within the scope of the present invention.

In this case, there is no particular restriction on the form of the program as long as it functions as a program. That is, the program may be realized in various forms such as an object code, a program executed by an interpreter, script data supplied to an operating system, etc.

Storage media which can be employed in the present invention to supply the program include a floppy disk, a hard disk, an optical disk, a magneto-optical disk, an MO disk, a CD-ROM disk, a CD-R disk, a CD-RW disk, a magnetic tape, a non-volatile memory card, a ROM, and a DVD disk.

In this case, the program code read from the storage medium implements the functions disclosed in the embodiments described above, and the storage medium on which the program code is stored falls within the scope of the present invention.

The program may also be supplied such that a client computer is connected to an Internet Web site via a browser, and an original computer program or a file including a compressed computer program and an automatic installer may be downloaded into a storage medium such as a hard disk of the client computer thereby supplying the program. The program code of the program according to an embodiment of the present invention may be divided into a plurality of files, and respective files may be downloaded from different Web sites. Thus, a WWW server, an ftp server and similar servers that provide a program or a file that allows the functions according to an embodiment of the present invention to be implemented on a computer also fall within the scope of the present invention.

The program according to the present invention may be stored in an encrypted form on a storage medium such as a CD-ROM and may be distributed to users. Particular authorized users are allowed to download key information used to decrypt the encrypted program from a Web site via the Internet. The decrypted program may be installed on a computer using the downloaded key information thereby achieving the one or more functions according to any embodiment of the present invention.

The functions disclosed in the embodiments may be implemented not only by executing the program code on a computer, but part or all of the process may be performed by an operating system or the like running on the computer in accordance with the program code. Such implementation of the functions also falls within the scope of the present invention.

Furthermore, the scope of the present invention also includes an apparatus/system in which a program code is loaded from a storage medium into a memory provided on a function extension board inserted in a computer or provided in a function extension unit connected to the computer, and then a part of or the whole of a process is performed by a CPU or the like in the function extension board or the function extension unit in accordance with the program code thereby implementing the functions of any embodiment described above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-292307 filed on Nov. 9, 2007, which is hereby incorporated by reference herein in its entirety.

What is claimed is:

1. A drawing-editing system comprising:
a drawing processing unit configured to draw a drawing object based on an input from a coordinate input apparatus;
a calculation unit configured to calculate a first speed indicating a drawing speed upon drawing of a first drawing object drawn by the drawing processing unit, and a second speed indicating a moving speed from a drawing end position of the first object to a drawing start position of a next, second drawing object to be drawn;
a determination unit configured to determine, based on information calculated by the calculation unit, whether to group the first drawing object and the second drawing object; and
a grouping processing unit configured to execute grouping of the first drawing object and the second drawing object based on a determination result of the determination unit.

2. The system according to claim 1, wherein when a difference between the first speed and the second speed calculated by the calculation unit falls within a predetermined range, the determination unit determines that the first drawing object and the second drawing object are grouped as the same group.

3. The system according to claim 1, wherein the calculation unit further calculates a time duration from a drawing end timing of the first drawing object until a drawing start timing of the second drawing object, and
the determination unit determines, based on the first speed, the second speed, and the time duration calculated by the calculation unit, whether to group the first drawing object and the second drawing object.

4. The system according to claim 1, wherein the calculation unit further calculates a distance from the first drawing object to the second drawing object, and the determination unit determines, based on the first speed, the second speed, and the distance calculated by the calculation unit, whether to group the first drawing object and the second drawing object.

5. The system according to claim 1, wherein the calculation unit further calculates a time duration from a drawing end timing of the first drawing object until a drawing start timing of the second drawing object, and a distance from the first drawing object to the second drawing object, and
the determination unit determines, based on the first speed, the second speed, the time duration, and the distance calculated by the calculation unit, whether to group the first drawing object and the second drawing object.

6. The system according to claim 4, wherein the calculation unit calculates, as the distance, a shortest distance from the drawing start position of the second drawing object to the first drawing object or a shortest distance from the second drawing object to the first drawing object.

7. The system according to claim 5, wherein the calculation unit calculates, as the distance a shortest distance from the drawing start position of the second drawing object to the first drawing object or a shortest distance from the second drawing object to the first drawing object.

8. The system according to claim 5, wherein the determination unit determines, based on a result obtained by processing information calculated by the calculation unit using an evaluation function, whether to group the first drawing object and the second drawing object.

9. A grouping processing method for a drawing-editing system, comprising the steps of:
drawing a drawing object based on an input from a coordinate input apparatus;
calculating a first speed indicating a drawing speed upon drawing of a first drawing object drawn in the drawing step, and a second speed indicating a moving speed from a drawing end position of the first object to a drawing start position of a next second drawing object to be drawn;
determining, based on information calculated in the calculation step, whether to group the first drawing object and the second drawing object; and
executing grouping of the first drawing object and the second drawing object based on a determination result of the determining step.

10. A computer-readable medium storing a computer-executable program for making a computer function as:
a drawing processing unit configured to draw a drawing object based on an input from a coordinate input apparatus;
a calculation unit configured to calculate a first speed indicating a drawing speed upon drawing of a first drawing object drawn by the drawing processing unit, and a second speed indicating a moving speed from a drawing end position of the first object to a drawing start position of a next, second drawing object to be drawn;
a determination unit configured to determine, based on information calculated by the calculation unit, whether to group the first drawing object and the second drawing object; and
a grouping processing unit configured to execute grouping of the first drawing object and the second drawing object based on a determination result of the determination unit.

11. A drawing-editing apparatus comprising:
a drawing processing unit configured to draw a drawing object based on an input from a coordinate input apparatus;
a calculation unit configured to calculate a first speed indicating a drawing speed upon drawing of a first drawing object drawn by the drawing processing unit, and a second speed indicating a moving speed from a drawing end position of the first object to a drawing start position of a next, second drawing object to be drawn;
a determination unit configured to determine, based on information calculated by the calculation unit, whether to group the first drawing object and the second drawing object; and
a grouping processing unit configured to execute grouping of the first drawing object and the second drawing object based on a determination result of the determination unit.
